(19) United States
(12) Patent Application Publication
(10) Pub. No.: US 2026/0179344 A1
(43) Pub. Date: Jun. 25, 2026

(54) ARTIFICIAL SATELLITE WITH ONBOARD GEORECTIFICATION OF IMAGE DATA

(71) Applicant: Xplore Inc., Mercer Island, WA (US)

(72) Inventors: Jeff Rich, Mercer Island, WA (US); Rey Ducay, Mercer Island, WA (US)

(73) Assignee: Xplore Inc., Mercer Island, WA (US)

(21) Appl. No.: 19/543,463

(22) Filed: Feb. 18, 2026

Related U.S. Application Data
(63) Continuation-in-part of application No. 19/057,506, filed on Feb. 19, 2025.
(60) Provisional application No. 63/564,279, filed on Mar. 12, 2024.

(51) Int. Cl. G06V 10/24; B64G 1/10; B64G 1/66; G06V 10/143; G06V 20/10; G06V 20/13

(52) U.S. Cl. CPC G06V 10/24; B64G 1/1007; B64G 1/1028; B64G 1/66; G06V 10/143; G06V 20/13; G06V 20/194

(57) ABSTRACT

The present invention is directed to a small, lightweight artificial satellite with edge computing capabilities. The artificial satellite is configured to perform onboard georectification and generation of analytics-ready data products. The artificial satellite includes at least one sensor operable to capture hyperspectral, multispectral, and/or video image data, and an onboard processor including at least one payload processor. The payload processor is operable to perform georectification and/or position rectification of image data using one or more onboard reference images, vector maps, positional data, and/or inter-satellite information, such that the image data is spatially accurate prior to transmission.

### CROSS-REFERENCE TO RELATED APPLICATIONS

This application is related to and claims priority from the following US patents and patent applications: this application is a continuation-in-part of U.S. patent application Ser. No. 19/057,506, filed Feb. 19, 2025, which claims priority from and the benefit of U.S. Provisional Patent Application No. 63/564,279, filed Mar. 12, 2024, each of which is incorporated herein by reference in its entirety.

### BACKGROUND OF THE INVENTION

### 1. Field of the Invention

The present invention relates to an artificial satellite capable of performing onboard imaging and processing, and more specifically to artificial satellites capable of performing onboard spatial processing including position rectification, georectification, and/or sensor fusion of data generated by optical, hyperspectral, multispectral, radio-frequency (including AIS, ADS-B), and/or video imaging sensors. The invention further relates to onboard utilization of reference data, vector maps, image-to-image matching techniques, and/or externally generated positional data including Automatic Identification System (AIS) signals to generate analytics-ready data products prior to transmission from orbit.

### 2. Description of the Prior Art

It is generally known in the prior art to provide to provide an artificial satellite with a sensor.

Prior art patent documents include the following:
U.S. Pat. No. 10,496,883 for Method and system for enhancing predictive accuracy of planet surface characteristics from orbit by inventor Kwan, filed Jan. 27, 2017 and issued Dec. 3, 2019, discloses a method and system for enhancing predictive accuracy of planet surface characteristics from orbit using an extended approach of Pan-Sharpening by using multiple high resolution bands to reconstruct high resolution hyperspectral image. Sparsity based classification algorithm is applied to rock type classification. An Extended Yale B face database is used for performance evaluation; and utilizing deep Neural Networks for pixel classification. The present invention presents a system that can significantly enhance the predictive accuracy of surface characteristics from the orbit. The system utilizes complementary images collected from imagers onboard satellites. The present system and method generates high spatial high spectral resolution images; accurate detection of anomalous regions on Mars, Earth, or other planet surfaces; accurate rock/material classification using orbital data and the surface characterization performance will be comparable to in-situ results; and accurate chemical concentration estimation of rocks.
US Patent Publication No. 2003/0095181 for Direct broadcast imaging satellite system apparatus and method for providing real-time, continuous monitoring of earth from geostationary earth orbit by inventor LeCompte, filed Nov. 20, 2002 and published May 22, 2003, discloses a system, method and apparatus for collecting an distributing real-time, high resolution images of the Earth from GEO include an electro-optical sensor based on multi-megapixel two-dimensional charge coupled device (CCD) arrays mounted on a geostationary platform. At least four, three-axis stabilized satellites in Geostationary Earth orbit (GEO) provide worldwide coverage, excluding the poles. Image data that is collected at approximately 1 frame/sec, is broadcast over high-capacity communication links (roughly 15 MHZ bandwidth) providing real-time global coverage of the Earth at sub-kilometer resolutions directly to end users. This data may be distributed globally from each satellite through a system of space and ground telecommunication links. Each satellite carries at least two electro-optical imaging systems that operate at visible wavelengths so as to provide uninterrupted views of the Earth's full disk and coverage at sub-kilometer spatial resolutions of most or selected portions of the Earth's surface.
US Patent Publication No. 2018/0167586 for Satellite imaging system with edge processing by inventors Rutschman et. al., filed Dec. 15, 2017 and published Jun. 14, 2018, discloses a satellite imaging system with edge processing includes, but is not limited to, at least one first imaging unit configured to capture and process imagery of a first field of view; at least one second imaging unit configured to capture and process imagery of a second field of view that is proximate to and larger than a size of the first field of view; and a hub processing unit linked to the at least one first imaging unit and the at least one second imaging unit.
US Patent Publication No. 2002/0041328 for Direct broadcast imaging satellite system apparatus and method for providing real-time, continuous monitoring of earth from geostationary earth orbit and related services by inventors LeCompte et al., filed Mar. 29, 2001 and published Apr. 11, 2002, discloses a system, method and apparatus for collecting an distributing real-time, high resolution images of the Earth from GEO include an electro-optical sensor based on multi-megapixel two-dimensional charge coupled device (CCD) arrays mounted on a geostationary platform. At least four, three-axis stabilized satellites in Geostationary Earth orbit (GEO) provide worldwide coverage, excluding the poles. Image data that is collected at approximately 1 frame/sec, is broadcast over high-capacity communication links (roughly 15 MHz bandwidth) providing real-time global coverage of the Earth at sub-kilometer resolutions directly to end users. This data may be distributed globally from each satellite through a system of space and ground telecommunication links. Each satellite carries at least two electro-optical imaging systems that operate at visible wavelengths so as to provide uninterrupted views of the Earth's full disk and coverage at sub-kilometer spatial resolutions of most or selected portions of the Earth's surface.
U.S. Pat. No. 10,647,449 for Indirect self-imaging systems and methods by inventors Wasson et al., filed May 30, 2018 and issued May 12, 2020, discloses a system includes a controller configured to determine a set of background light intensities associated with a satellite, where each background light intensity corresponds to at least one of an orientation and a position of a light source relative to the satellite, to determine a set of relative orientations of the light source corresponding to the set of background light intensities, and to generate an image of the satellite based, at least in part, on the determined set of background light intensities and the determined set of relative orientations of the light source.
U.S. Pat. No. 11,496,679 for Real-time satellite imaging system by inventor Williams filed Feb. 8, 2021 and issued Nov. 8, 2022, discloses methods and apparatus for Real-time Satellite Imaging System. More particularly, one embodiment of the present invention an imaging sensor on a geostationary satellite having one or more co-collimated telescopes. The telescopes illuminate local planes which are sparsely populated with focal plane arrays. The focal plane arrays record the entire observable Earth hemisphere at one time, at least once every ten seconds.
U.S. Pat. No. 7,090,170 for In-orbit satellite sensor alignment determination by inventor Kau, filed Nov. 22, 2002 and issued Aug. 15, 2006, discloses a sensor alignment system and method is provided that facilitates the precise alignment determination of satellite sensors. The system and method utilizes an Inertial Measurement Unit (IMU) to facilitate alignment determination of multiples sensors on a satellite. The system and method performs a roll of the satellite around a preliminary sensor active axis, using the IMU to measure the rotation rate in both magnitude and direction. The sensor input is monitored by the IMU during the roll around the preliminary sensor axis. The data from sensor output obtained during the roll can be processed to calculate the difference between the preliminary sensor axis and the actual sensor axis. From this calculation the actual alignment of the sensor axis can be determined. Furthermore, by performing this alignment determination operation for multiple sensors the relative alignment between sensors can be determined.
US Patent Publication No. 2020/0371373 for Focal plane assembly of remote sensing satellite and image processing method thereof by inventors Ling et al., filed Jun. 24, 2019 and published Nov. 26, 2020, discloses a Focal Plane Assembly (FPA) of a remote sensing satellite for receiving a focal plane image provided by an optical lens, comprises a sub-pixel shifting field separator, a first linear image sensor, and a second linear image sensor. The field separator split the focal plane image up into a first half focal plane image and a second half focal plane image, the first linear image sensor, located at an edge of a half focal plane, receives the first half focal plane image to generate a first image, the second linear image sensor, located at an edge of another half focal plane, receives the second half focal plane image to generate a second image, wherein a sub-pixel shifting relation is between the first image and the second image.
US Patent Publication No. 2022/0242593 for Artificial satellite and control method thereof by inventors Ezawa, et al., filed Dec. 3, 2021 and published Aug. 4, 2022, discloses an artificial satellite and a control method thereof that enable to ensure quality of a captured image while suppressing battery consumption. An artificial satellite includes: an imaging device configured to perform imaging of a predetermined region on the ground; and a management unit configured to change accuracy of attitude control in accordance with a remaining battery amount at an instructed imaging time, and configured to change an imaging condition in accordance with accuracy of the attitude control. The present technology can be applied to, for example, an artificial satellite or the like that performs satellite remote sensing by formation flight.
Chinese Patent No. 110,516,588 for Remote sensing satellite system by inventors Weijian et al., filed Aug. 23, 2019 and issued Apr. 18, 2023, discloses a remote sensing satellite system which comprises a first satellite, wherein the first satellite comprises at least four image sensors, the at least four image sensors are used for simultaneously acquiring images of the ground, the ground areas acquired by the at least four image sensors are completely or partially overlapped, the spatial resolution and the spectral resolution of the images acquired by the at least four image sensors are different from each other, and the first satellite is used for carrying out image fusion on at least one part of the images acquired by the at least four image sensors so as to generate a fused remote sensing image. The invention can efficiently obtain the remote sensing image with high definition by using the limited resources of the satellite.
Chinese Patent No. 109,018,432 for High-precision comprehensive remote sensing satellite layout for multi-load cooperative observation by inventors Jinru et al., filed Jun. 19, 2018 and issued May 29, 2020, discloses a high-precision comprehensive remote sensing satellite layout for multi-load cooperative observation, which effectively ensures harsh working environments of active detection loads such as laser radars and the like through an eccentric deflection high-precision high-stability installation layout; by means of common reference installation, transmission path reduction and the like, the requirement of low-deformation precision cooperative observation of dual-polarization load angle grading view field registration is met, and an interface between systems is simplified; based on the existing mixed nested layered stepped satellite platform configuration, the overall installation layout of the complex constraint load/antenna/attitude sensor with the same platform, various types, different envelopes, weights and use requirements, and multi-hand synthesis is realized, the satellite development risk and cost are reduced, and the satellite development period is shortened. The invention can be applied to the low-orbit comprehensive remote sensing satellite with the cooperative observation requirements of the loads with different envelopes and different weights on the same platform, which has the advantages of large volume envelope, large concentration mass, large heat flow density, high-precision and high-stability installation and complex visual field constraint.
Chinese Patent Publication No. 109,844,471 for Spectral luminosity measuring device with multiple spectral measurement wave bands by inventor Pasternak, filed Sep. 29, 2017 and published Apr. 27, 2021, discloses a spectrophotometric measuring device has a plurality of spectral measuring bands, including a single telescope and a single spectrophotometer. A plurality of spectral bands are obtained by placing aperture splitting prisms at the entrance aperture (PE) of the telescope and by using a spectral band selection filter. Such devices are lightweight, small in size and low in cost. In particular, it can be integrated into satellites, in particular for the task of characterizing the flow of carbon compounds generated at the surface of the earth.
Chinese Patent Publication No. 108,557,114 for A kind of distribution remote sensing satellite by inventors Yong et al., filed Apr. 18, 2018 and published Sep. 21, 2018, discloses a kind of distributed remote sensing satellites comprising a service star and six remote sensing unit stars, and distributed formation mode or synthetic aperture integrated mode can be used in the service star and remote sensing unit star.
Canadian Patent No. 3067604 for System and method for widespread low cost orbital satellite access by inventor Platzer, filed Feb. 3, 2014 and issued Jul. 12, 2022, discloses a large constellation of low-cost satellites with a satellite support and administration system that allows widespread user access to advanced satellite technology at extremely low costs. Any portion of the constellation can be tasked and configured for specific data capture. In one embodiment, a constellation of individual satellites are employed to concurrently collect occultation data from multiple GPSS originating signals that pass through atmospheric sections of interest. Alternately, the constellation can be configured as a vehicle location tracking system that receives multiple vehicle tracking signals and based thereon, track within a system grid each vehicle under surveillance. The system can use AIS for ocean going vessels, ADS-B for aircraft, and AEI for trains. Use of the system permits extended tracking of key cargos and the protection of vehicles from piracy and the like.

### SUMMARY OF THE INVENTION

The present invention relates to an artificial satellite capable of performing onboard imaging and processing, and more specifically to artificial satellites capable of performing onboard spatial processing including position rectification, georectification, orthorectification, and/or sensor fusion of data generated by optical, hyperspectral, multispectral, and/or video imaging sensors. The invention further relates to onboard utilization of reference data, vector maps, image-to-image matching techniques, and/or externally generated positional data including Automatic Identification System (AIS) signals to generate analytics ready data (ARD) products prior to transmission from orbit.

It is an object of this invention to provide a single artificial satellite with at least one sensor type, with the satellite capable of onboard position rectification, georectification, orthorectification, image alignment, and/or other transformations, as well as resolution enhancement operations including pan-sharpening, to generate spatially aligned and analytics-ready data products prior to transmission from the artificial satellite.

In one embodiment, the present invention is related to an artificial satellite, including a satellite body, an imaging sensor attached to the satellite body, wherein the imaging sensor is operable to generate image data representing a sensed environment, a memory attached to the satellite body and operable to store reference data having a known position, and a processor attached to the satellite body and in communication with the imaging sensor and the memory, wherein the processor is operable to perform position rectification on the image data using the reference data stored in the memory, and wherein the position rectified image data includes an analytics-ready data (ARD) product prior to transmission of the position rectified image data from the artificial satellite to a ground station or a second artificial satellite.

In another embodiment, the present invention is related to an artificial satellite, including a satellite body, an imaging sensor attached to the satellite body, wherein the imaging sensor is operable to generate image data representing a sensed environment, a memory attached to the satellite body and operable to store reference data having a known position, and a processor attached to the satellite body and in communication with the imaging sensor and the memory, wherein the processor is operable to perform position rectification on the image data using the reference data stored in the memory to associate features within the image data with the reference data, and wherein the image data includes spatial position information prior to transmission from the artificial satellite to a ground station or a second artificial satellite.

In yet another embodiment, the present invention is related to an artificial satellite, including a satellite body, an imaging sensor attached to the satellite body, wherein the imaging sensor is operable to generate image data representing a sensed environment, a memory attached to the satellite body and operable to store reference data having a known position, and a processor attached to the satellite body and in communication with the imaging sensor and the memory, wherein the processor is operable to associate features within the image data with the reference data to automatically correct the image data via orthorectification, georectification, and/or pan sharpening to create an analytics-ready data product comprising spatial position information prior to transmission from the artificial satellite to a ground station.

These and other aspects of the present invention will become apparent to those skilled in the art after a reading of the following description of the preferred embodiment when considered with the drawings, as they support the claimed invention.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates a perspective view of an artificial satellite with a plurality of sensors according to one embodiment of the present invention.

FIG. 2 illustrates a schematic diagram of data flow between a satellite having a plurality of sensors communicating with one or more ground stations according to one embodiment of the present invention.

FIG. 3 illustrates a grayscale image representation of hyperspectral image data depicting an environment according to one embodiment of the present invention.

FIG. 4 illustrates a red, blue, and green (RGB) image representation of hyperspectral image data depicting an environment according to one embodiment of the present invention.

FIG. 5 illustrates a RGB image representation of hyperspectral image data of a maritime environment according to one embodiment of the present invention.

FIG. 6 illustrates a zoomed in RGB image representation of hyperspectral image data of a maritime environment according to one embodiment of the present invention.

FIG. 7 is a schematic diagram of a system of the present invention.

### DETAILED DESCRIPTION

The present invention relates to an artificial satellite capable of performing onboard imaging and processing, and more specifically to artificial satellites capable of performing onboard spatial processing including position rectification, georectification, and/or sensor fusion of data generated by optical, hyperspectral, multispectral, and/or video imaging sensors. The invention further relates to onboard utilization of reference data, vector maps, image-to-image matching techniques, and/or externally generated positional data including Automatic Identification System (AIS) signals to generate analytics-ready data products prior to transmission from orbit.

In one embodiment, the present invention is related to an artificial satellite, including a satellite body, an imaging sensor attached to the satellite body, wherein the imaging sensor is operable to generate image data representing a sensed environment, a memory attached to the satellite body and operable to store reference data having a known position, and a processor attached to the satellite body and in communication with the imaging sensor and the memory, wherein the processor is operable to perform position rectification on the image data using the reference data stored in the memory, and wherein the position rectified image data includes an analytics-ready data product prior to transmission of the position rectified image data from the artificial satellite to a ground station or a second artificial satellite.

In another embodiment, the present invention is related to an artificial satellite, including a satellite body, an imaging sensor attached to the satellite body, wherein the imaging sensor is operable to generate image data representing a sensed environment, a memory attached to the satellite body and operable to store reference data having a known position, and a processor attached to the satellite body and in communication with the imaging sensor and the memory, wherein the processor is operable to perform position rectification on the image data using the reference data stored in the memory to associate features within the image data with the reference data, and wherein the image data includes spatial position information prior to transmission from the artificial satellite to a ground station or a second artificial satellite.

In yet another embodiment, the present invention is related to an artificial satellite, including a satellite body, an imaging sensor attached to the satellite body, wherein the imaging sensor is operable to generate image data representing a sensed environment, a memory attached to the satellite body and operable to store reference data having a known position, and a processor attached to the satellite body and in communication with the imaging sensor and the memory, wherein the processor is operable to associate features within the image data with the reference data to automatically correct the image data via orthorectification, georectification, and/or pan sharpening to create an analytics-ready data product comprising spatial position information prior to transmission from the artificial satellite to a ground station.

These and other aspects of the present invention will become apparent to those skilled in the art after a reading of the following description of the preferred embodiment when considered with the drawings, as they support the claimed invention.

None of the prior art discloses on satellite georectification using images captured onboard, onboard processing, and onboard reference information. The source of both the captured images and the processing occur in orbit, which represents a fundamental architectural distinction from existing satellite imaging systems and enables low-latency analytics-ready data delivery from orbit to an end-user.

Artificial satellites have a variety of uses and have become an integral part of modern life. Artificial satellites aid in Earth observation, outer space observation, communication systems, navigation systems, and even weapon systems. Traditionally, artificial satellites include electricity generation systems, such as solar panels, to power the onboard equipment. Importantly, artificial satellites require a power generation system operable to produce enough power to support its onboard equipment, otherwise the equipment cannot function. Consequently, the greater the number of sensors or the greater the power demand of the sensors, the more power need by the power generation system. Therefore, there is a need for an artificial satellite capable of supporting multiple sensors.

However, the issue with the distribution of sensors around a constellation, or multiple constellations of satellites, rather than integrated on a single satellite, is not just the number of satellites required, but the increased latency that this prior art system of organization necessarily requires. For example, the existing system requires a ground station to essentially ping the satellite for specific data, and likely needing to ping multiple satellites for multiple data sets, transmit the information back down to the ground station, perform sensor fusion, post-process the data, and then subsequently transmit the relevant information to an intended destination. Therefore, a system that provides onboard sensor fusion and data processing allows the processed data to be immediately transferred from the processing satellite to the intended destination, without requiring that the ground processing systems receive and process the information as an intermediary. Thus, a system is needed to resolve the inefficiency of current satellite communication.

In one embodiment, the artificial satellite includes at least two sensors. In one embodiment, the artificial satellite includes at least three sensors. In one embodiment, the artificial satellite includes at least four sensors. In one embodiment, the artificial satellite includes at least five sensors. In one embodiment, the artificial satellite includes at least three sensors wherein at least one sensor is a high-power, high-resolution sensor. In one embodiment, the artificial satellite includes a plurality of sensors.

In one embodiment, the artificial satellite is of a small size and is not a large spacecraft. In one embodiment, the artificial satellite weighs approximately 180 kg.

One of ordinary skill in the art will understand that the inclusion of onboard processing and multiple sensors on a single satellite does not mean that the satellite of the present invention is not able to be included in a constellation of a plurality of satellites. In one embodiment, a satellite of the present invention is included in a constellation of 15 satellites, or any other number of satellites. In some embodiments, use of a plurality of satellites according to the present invention provides an advantage due to the different angles at which different satellites in the constellation are able to observe the same feature or different features, even if the different satellites include substantially the same type of sensors.

In one embodiment, the satellite is able to communicate with ground stations or with other satellites in a constellation via S-band (approximately 2-4 GHz, or more particularly 2.31-2.36 GHz, 2-2.2 GHz, or approximately 2.6 GHz), X-band (approximately 7-11.2 GHz, or more particularly 7.25 GHz to 7.75 GHz or 7.9 GHZ to 8.4 GHz), low latency L-band (approximately 1-2 GHz, or more particularly frequencies such as 1176.45 MHz, 1227.6 MHz, 1381.05 MHz, or 1575.42 MHz), via optical inter-satellite link (OISL) communications, or via Ka-band (between approximately 26.5-40 GHz, or more particularly between approximately 27 GHz and 31 GHz).

In one embodiment, the plurality of sensors includes a Red, Blue, and Green (RGB), an optical sensor, two hyperspectral sensors, one automatic identification system (AIS) receiver, and two ultraviolet instruments (e.g., two ultraviolet telescopes). In one embodiment, the plurality of sensors includes any number or combination of at least one RGB video telescope, at least one hyperspectral sensor, at least one ultraviolet instrument, at least one infrared spectrometer, and/or at least one AIS receiver. In one embodiment, the plurality of sensors include one or more optical sensors, one or more hyperspectral sensors, one or more infrared sensors (e.g., infrared cameras, infrared telescopes, infrared spectrometers, etc.), one or more ultraviolet sensors, one or more AIS receivers, one or more radiofrequency receivers, one or more dosimeters, one or more magnetometers, one or more LiDAR sensors, one or more spectrometers, one or more automatic dependent surveillance-broadcast (ADS-B) systems, and/or one or more synthetic aperture radar (SAR) systems. In one embodiment, the artificial satellite includes at least one RGB video telescope and at least one hyperspectral sensor. In one embodiment, the artificial satellite includes at least one RGB video telescope, at least one hyperspectral sensor, and at least one ultraviolet instrument. In one embodiment, the artificial satellite includes at least one RGB video telescope, at least one hyperspectral sensor, at least one ultraviolet instrument, and at least one infrared telescope. In one embodiment, the plurality of sensors includes any combination of five or fewer of the aforementioned sensors.

In one embodiment, the plurality of sensors are operable to capture image data. In one embodiment, the artificial satellite includes at least one transmitter operable to transmit the image data from the plurality of sensors. In one embodiment, the artificial satellite includes at least one transceiver operable to transmit and receive data.

In one embodiment, the satellite includes a plurality of onboard processing computers configured to perform tasks such as sensor fusion and other processing of the data generated from the plurality of sensors. In a preferred embodiment, the satellite includes two flight processors (i.e., processors dedicated to tasks relating to the movement and navigation of the satellite) and four payload processors (i.e., processors dedicated to processing tasks related to the sensors), but one of ordinary skill in the art will understand that other combinations of flight and payload computers are also contemplated herein. In one embodiment, the satellite includes approximately 10 TB of memory storage.

Examples of processing tasks able to be performed by the payload processors onboard the satellite include orthorectification, other georectification, radiometric correction, and pan sharpening, among others. Orthorectification is a form of georectification that is important for removing distortion from the image data produced by sensors onboard the satellite, and is especially important such that measurements such as distances, angles, and areas of features in the image data is able to be accurately determined. The distortion corrected in orthorectification is typically caused by differences in elevation of the area being imaged (e.g., due to mountains, valleys, buildings, etc.), the curvature of the Earth, the tilt of the imaging device on the satellite, and the movement of the satellite while the image is being generated. Without orthorectification, the elevation differences cause the actual position of imaged objects to be displaced from their actual position, making tasks that require actual mapping difficult if not impossible. In the prior art, this process of orthorectification occurs on a ground station after image data from the satellite is received, using a digital elevation model (DEM), commonly generated from multiple full passes of satellite mapping by separate satellites, which often include LiDAR, Radar, or stereophotogrammetric based sensors. However, this process introduces large amounts of latency, both in the generation of a sufficient DEM model to provide an accurate orthorectification, and in the actual transmission back to a ground station for the post-processing.

The present invention overcomes these limitations of prior art orthorectification by performing the orthorectification onboard the satellite itself using the payload processors. In one embodiment, a DEM is generated for orthorectification using sensor data from other sensors onboard the same satellite (e.g., optical sensors, video sensors, ultraviolet sensors, etc.), either using the same type of sensor oriented at a different angle, or using different types of sensors from the sensor data being rectified. Alternatively, the satellite is able to communicate with other satellites in a constellation also generating sensor data using the same or different types of sensors and process this data from other satellites along with data generated by the processing satellite itself in order to orthorectify the mapping image. In this way, the present invention does not require the data to be transmitted and processed at a ground station, but is instead able to be processed onboard and transmitted directly to the target destination.

The satellite according to the present invention is also able to perform radiometric correction using the onboard payload processors of the satellite. Radiometric correction is important for obtaining accurate pixel values for the images obtained by one or more sensors on the satellite to ensure that the images are accurate and comparable to other images. The correction involves converting the digital numbers (DNs) of the satellite image to spectral radiance and reflectance. This often requires calibration and processing to eliminate weather-related distortion of the images, which is often variable depending both on current weather conditions and on the current season in which the images are produced. Some methods for calibration and other forms of correction are able to be performed without secondary sensor data using known calibration factors for a particular area during a particular time period, or using correlation to baseline data for an area, as discussed in the article Radiometric Correction with Topography Influence of Multispectral Imagery Obtained from Unmanned Aerial Vehicles by Jenerowicz et al., which is incorporated herein by reference in its entirety. Alternatively, the present system is able to use data from different imaging systems on the same satellite (or from other satellites in a constellation) to prevent for an amount of correction needed for weather effects or to calibrate the image data (e.g., infrared sensor data used to provide correction for hyperspectral image data, etc.).

The satellite of the present invention is further capable of performing pan sharpening using the onboard payload processors. One critique of satellite imagery is that with a single sensor, the image data from the satellite either only has quality spatial resolution or spectral resolution, with one of these two qualities lacking. Existing pan sharpening methods have reconciled this tradeoff by using sensor fusion between a panchromatic image and multispectral image of the same area to sharpen the image to have both high spectral and spatial resolutions. However, as with other processing techniques, the nature of prior art systems as only including a single sensor or imaging systems means that this pan sharpening generally requires sensor fusion to be performed at a ground station to receive image data from two different satellites. However, because the satellite of the present invention includes a plurality of sensors, including those capable of producing both panchromatic and multispectral images, such sensor fusion is able to be performed using sensor data produced by sensors on a single satellite. Furthermore, the satellite is then able to further processing needed to perform the pan sharpening processing with the onboard payload processors. One of ordinary skill in the art will understand that, according to another embodiment, a first satellite is able to receive image data from one or more other secondary satellites used to sharpen images produced by the first satellite and then perform the pan sharpening using the onboard payload processors.

In one embodiment, the plurality of sensors are mounted on at least one gimbal. In one embodiment, the at least one gimbal is a pivoted support member that permits rotation about a plurality of axes. In one embodiment, the gimbal enables the plurality of sensors to rotate independent of the movement or rotation of the artificial satellite. In one nonlimiting example, the at least one gimbal enables the plurality of sensors to be directed towards the Earth while the artificial satellite, or the solar array of the artificial satellite in one embodiment, is directed towards the sun.

In one embodiment, the at least one RGB video telescope is operable to capture 8K full-color video, that is video with approximately 9,000×7,000 pixel resolution per frame.

In one embodiment, the at least one hyperspectral sensor is operable to produce 5-meter resolution hyperspectral imaging. The hyperspectral imaging includes chemistry data for agriculture, security, energy, and environmental monitoring. The hyperspectral sensor is operable to capture 440 bands of electromagnetic data. The hyperspectral sensor is operable to collect electromagnetic data in a series of set images with each image representing a specific narrow wavelength. The images are then combined to create a three-dimensional hyperspectral data set for processing and analysis. In one embodiment, the hyperspectral data set includes x and y coordinates representing two spatial dimensions of the captured area with a third 2 coordinate representing the spectral dimension or range of wavelengths captured.

In one embodiment, the at least one ultraviolet instrument is operable to capture electromagnetic radiation data in the ultraviolet range (100-400 nm). In this embodiment, the ultraviolet telescope is operable to capture line spectrum data within the ultraviolet range to determine chemical compositions, densities, and temperatures of the captured area. Advantageously, the ultraviolet instrument provides information about the evolution of galaxies, the presence of hot white dwarfs, and main sequences in orbit around cooler stars.

In one embodiment, the at least one infrared spectrometer is operable to capture electromagnetic radiation data in the infrared range (780-2400 nm). In this embodiment, the infrared spectrometer is operable to capture line spectrum data within the infrared range to monitor greenhouse gases in the captured area. In one embodiment, the infrared spectrometer is operable to produce infrared spectrum data. Infrared spectrum data is visualized on a graph with a vertical axis of infrared light absorbance against frequency, wavenumber, and/or wavelength on the horizontal axis.

In one embodiment, the at least one AIS receiver is operable to receive AIS signatures from ships for vessel traffic services (VTS). In one embodiment, the AIS signatures include unique identification, position, course, and speed data. In one embodiment, the artificial satellite is operable to deconflict AIS signatures. In one embodiment, the artificial satellite includes a transceiver operable to transmit the AIS signatures. Advantageously, by inclusion of the AIS receiver, the artificial satellite assists vessels' watchstanding officers and enables maritime authorities to track and monitor vessel movement.

In one embodiment, the satellite according to the present invention receives tasks as uplink messages from at least one ground station. In one embodiment, the tasks are routed through one or more relay satellites (e.g., via another constellation such as the Iridium network). The tasks designate a desired type of data to generate, including raw sensor data, and/or processed sensor data based on raw sensor data from one or more of the sensors onboard the satellite. In one embodiment, the tasks include a target (e.g., a destination device or node), a time (e.g., time at which task was sent, time at which the data should be delivered, etc.), one or more designated sensors to utilize, a designated data product, analytics, and/or a desired distribution method or path for the task and/or for the data (e.g., which relay networks to use, what frequency bands to utilize, etc.). In one embodiment, the tasks include a destination device or node to which the information is to be delivered. The destination device or node is able to be the same or distinct from the device or node transmitting the task to the satellite, and is able to include both in-orbit, aerial, or terrestrial devices. In one embodiment, the raw sensor data and/or processed sensor data generated as a result of the task is able to be routed through one or more relay satellites or ground station to the destination end user device or node. Because the processing for the task is able to be, partially or entirely, performed on-board the satellite, the data from the satellite does not need to be routed back through the task-transmitting ground station before being send to the destination and is instead able to be directly transmitting by the satellite to the destination device or node.

In one embodiment, tasks are able to be input into a tasking application or application programming interface (API) on a user device (e.g., a cell phone, a computer, a tablet, etc.). In one embodiment, the tasking application or API includes set parameters to input (e.g., target, time, sensors, analytics, distribution path, etc.) for the task being transmitted and is able to set certain categories of information as mandatory or discretionary.

The range of applications and technical fields for each task are able to be generated and requested vary widely. In one contemplated embodiment, the tasks relate to identification of the relative or absolute (i.e., actual geodetic) locations of a plurality of vessels, such as ships, within a specific area. This is especially useful in situations where the ships disable their AIS transponder, lack an AIS transponder, where the AIS transponder is malfunctioning, or where the AIS transponder is otherwise unable to communicate to transmit information. The application to maritime situations is useful for a variety of situations, including rescue for ships, port management and security, and for warfare applications where non-transmitting vessels need to be identified. For applications such as these, the low latency enabled by the onboard sensor fusion and data processing aboard the satellites is critical for enabling sufficiently fast determinations of vessel locations to be made.

Sensor fusion of the particular sensors of the present invention, such as the combination of the imaging sensors (e.g., hyperspectral, RGB video, etc.) and the AIS receiver, allows for enhancing of the results of the individual sensors to provide for unique results. For example, in instances in a ship is imaged in the middle of the ocean or sea without any geographic features nearby, the AIS receiver is able to be used to provide a geolocation (e.g., a GPS location) for the ship so as to allow the ship to serve as a geodetic marker for the image, allowing for the image including the ship to be better combined with other image data to create a complete mapping of an area. On the other hand, use of the imaging sensor is able to be used to provide context or additional information regarding an AIS located vessel, or able to back fill to determine a location of the vessel even if the AIS transponder of the vessel is not functioning or is out of range of other receivers. Port and land-based AIS transponders are also operable to be used to provide accurate position information, as their locations are static.

In one embodiment, the payload processors are able to perform a variety of processing tasks, including classification, identification, and tagging of identified objects in images produced by the sensors on the satellite. In one embodiment, this classification, identification, and tagging is performed by, at least in part, one or more artificial intelligence or machine learning (AI/ML) modules that form part of the payload processors. By way of example and not limitation, tasks are able to be assigned to command the payload processors to automatically detect ships, planes, other vehicles, buildings (or specific building types), terrain features, people, animals, weather phenomena (e.g., fires, tornadoes, etc.), and/or other features in the images and automatically provide geolocation data for one or more of the identified features. In one embodiment, the payload processors are able to perform tasks identifying changes to the images and/or changes to one or more identified objects in the images. For example, in one embodiment, the payload processors are operable to perform onboard pattern of life analysis, change analysis, and/or anomaly detection based on the image or video data produced by the plurality of sensors on the satellite. In one embodiment, the payload processor is able to determine an approximate velocity, direction, acceleration, and/or position of one or more objects identified in the images or video produced by the plurality of sensors.

In one embodiment, the payload processors are able to provide homomorphic encryption and/or other forms of encryption for the sensor data before transmitting the sensor data to the destination device or node.

In one embodiment, the present invention demonstrates low-latency, with a delay of only between about 5 seconds and about 20 seconds for the task to reach the satellite from the ground station and about 5 seconds to about 20 seconds for the data generated by the satellite to reach the destination device or node.

In one embodiment, the plurality of sensors are operable to capture image data from the Earth for Earth observation, weather forecasting, agriculture monitoring, and/or greenhouse gas monitoring. In one embodiment, the plurality of sensors are operable to capture image data from outer space to collect information about planets, meteorites, stars, distant galaxies, and/or other outer space objects.

In one embodiment, the plurality of sensors are all directed to a common target, simultaneously and are operable to obtain image data from the plurality of sensors on the same common target. In this embodiment, the image data is combined, overlayed, and/or integrated for analytical purposes.

In one embodiment, the artificial satellite includes a power system operable to produce enough power to support the plurality of sensors and/or analysis of image data captured by the plurality of sensors.

In order to provide sufficient power in order to support the multiple sensors onboard the satellite and the electric propulsion system of the satellite, in one embodiment, the satellite includes power systems providing approximately 1 kW of power. In one embodiment, the power is provided by one or more solar cells of the satellite, one or more batteries, and/or combinations thereof.

Referring now to the drawings in general, the illustrations are for the purpose of describing one or more preferred embodiments of the invention and are not intended to limit the invention thereto.

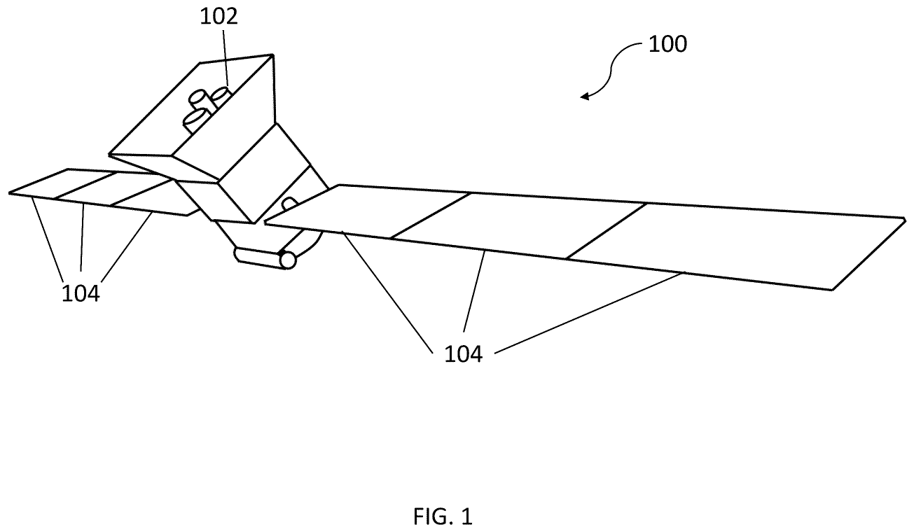

FIG. 1 illustrates a perspective view of an artificial satellite 100 with a plurality of sensors 102 according to one embodiment of the present invention. In one embodiment, the plurality of sensors 102 are mounted to a top center side of the artificial satellite 100. In one embodiment, the artificial satellite 100 includes a plurality of solar panels 104.

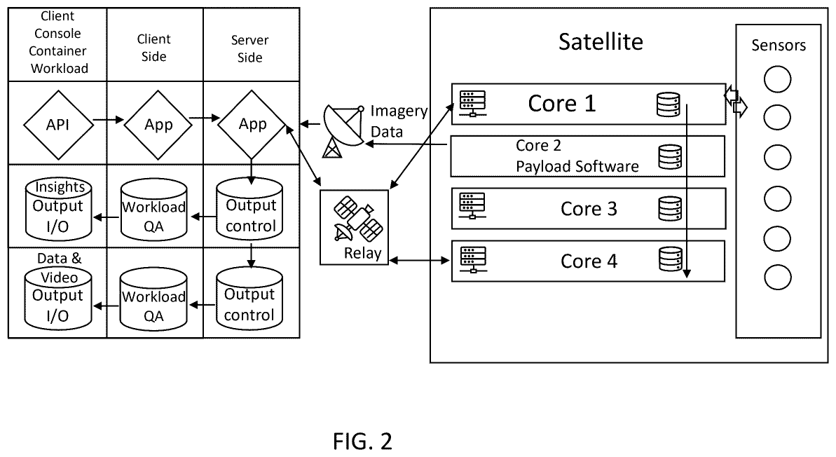

FIG. 2 illustrates a schematic diagram of data flow between a satellite having a plurality of sensors communicating with one or more ground stations. As shown in FIG. 2, a plurality of sensors onboard one or more satellites communicate sensor data with one or more core processors onboard the satellite. In one embodiment, the processors are split between those that receive signals from ground stations and/or relay satellites and those that process the sensor data, while, in another embodiment, the processors are capable of performing wide varieties of tasks.

The processors of the satellite are capable of receiving tasks, commands, and other messages from a server application in a ground station, optionally relayed through one or more intermediary satellite networks. The server application itself includes a client application programming interface (API) capable of receiving the commands of what server data to generate either directly from an operator or from automatic task generation (e.g., rules-based task generation, artificial intelligence task generation, etc.). A ground-based application is also capable of receiving imagery data processed by the satellite either at the same ground station or a different ground station from the one that originally transmitted the task. This imagery data is then able to be further processed for output control, stored in a ground or satellite-based database, and utilized to generate insights about a particular area or identified object, depending on the objectives of the task.

### Onboard Georectification and System Overview

The present application is directed to performing onboard georectification of satellite-generated image data, and more specifically to performing georectification and/or position rectification of hyperspectral, multispectral, and/or video imagery on orbit rather than at a ground station. The system includes at least one imaging sensor, at least one payload processor, at least one memory, and at least one transceiver, and introduces an onboard system that generates analytics-ready data products prior to downlink. As described herein, the term “analytics-ready data product” refers to image data generated by an artificial satellite that includes embedded spatial position information resulting from onboard position rectification and/or georectification, such that the image data is immediately usable by downstream analytical software/Geographic Information System (GIS) without requiring additional ground-based spatial correction or preprocessing. As described herein, the term “position rectification” refers to an onboard processing operation performed by the at least one payload processor of the artificial satellite that associates features within satellite-generated image data with known spatial reference information (including georeferenced or georectified images/maps, vector maps, and/or Automatic Identification System (AIS) data from a ship) to determine and assign spatial position information to the image data prior to transmission from the satellite. In one embodiment, position rectification is operable to include georectification and rectification of an image to an environment other than Earth.

In one embodiment, the payload processor executes orthorectification and/or georectification algorithms on image data generated by at least one hyperspectral sensor, at least one RGB video imaging sensor, and/or at least one multispectral imaging sensor. In this embodiment, the system performs georectification entirely on orbit, such that the image data transmitted from the satellite includes known spatial coordinates and is immediately usable by downstream analytics systems without additional ground-based preprocessing.

Georectification is a required step for transforming image data captured from space into a spatially accurate representation of the Earth or other captured environments. Without georectification, images and/or videos lack precise correspondence to real-world locations/maps, severely limiting scientific, commercial, and/or defense analysis. Existing systems perform this step on the ground in manual or semi-automated workflows, introducing latency. The present system improves these limitations by performing georectification or position rectification onboard the satellite using onboard data, onboard processing, and onboard reference information.

### Onboard Reference Data and Vector Map Storage

In one embodiment, the payload processor performs georectification using an onboard reference data set stored in an onboard memory. In one embodiment, the artificial satellite includes at least 8 terabytes of onboard storage allocated to geospatial reference data. The reference data is operable to include a vector-based map comprising roads, road intersections, coastal outlines, shorelines, buildings, city layouts, political boundaries, and/or other fixed landmarks.

In one embodiment, the vector map includes substantially all available road networks on Earth as a vectorized map stored in memory onboard the satellite. This allows for the ability to georectify a terrestrial image to a coordinate system for use in a GIS given enough relevant reference data in the image. In another embodiment, the vector map represents a predefined geographic region of interest. In yet another embodiment, the vector map includes multiple regional datasets selectable by the payload processor based on tasking instructions received via the transceiver. In another embodiment, the vector map or vector map region is operable to be updated and/or adjusted over time or on command by an upload via at least one onboard optical receiver. The vector map is further operable to be stored in a compressed format optimized for onboard memory access and near real-time spatial matching.

The payload processor is operable to extract features from image data generated by the hyperspectral sensor and/or other imaging sensors and perform matching between the extracted features and corresponding vector features stored in memory. The matching process is operable to include identification of edges, linear features, intersections, contours, and/or spatial relationships, and computation of a transformation that aligns the image data to a known coordinate system.

In one embodiment, vector features are operable to be extracted from hyperspectral imagery by identifying materials within the captured area based on spectral signatures unique to the materials and using the material classifications and/or the spectral signatures to enhance geometric feature detection. Hyperspectral data is operable to provide reflectance information across numerous spectral bands, enabling the payload processor to distinguish between materials including water, asphalt, concrete, vegetation, soil, rust, and/or metal types. For example, and not limitation, rivers, lakes, and/or coastlines are operable to be identified by the characteristic spectral absorption features of water; roads, parking areas, and/or rail lines; airport runways are operable to be identified by spectral signatures associated with metal, asphalt, or concrete; shorelines are operable to be identified by transitions between water and land spectral classes. While some feature identification may be possible without hyperspectral data, incorporating hyperspectral imagery and spectral signatures significantly improves both accuracy and verification. Hyperspectral imagery is particularly important for geometric features used in many georectification methods, including roads, rail lines, rivers, and/or coastlines. In addition, hyperspectral data is operable to enhance edge detection by distinguishing differences in material composition, even when color contrast is minimal. For example, and not limitation, roads that transition between surface materials may appear visually similar to their surroundings in standard imagery yet exhibit distinct spectral signatures. This improved edge delineation is important for precise feature extraction and, ultimately, for georectification accuracy.

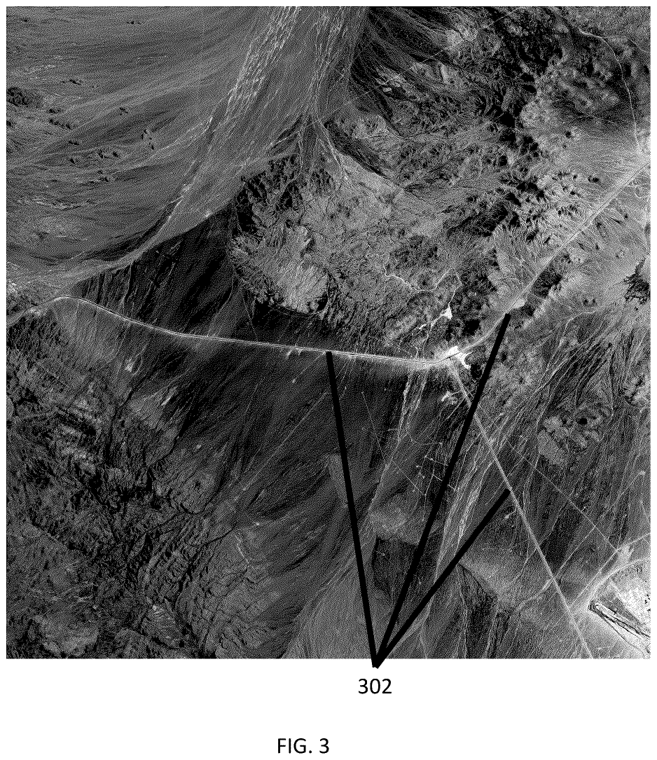

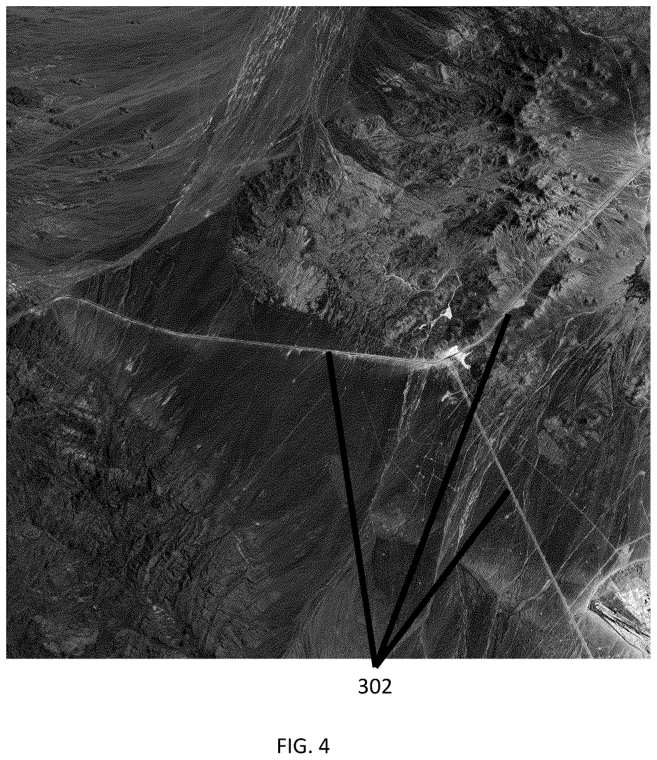

FIGS. 3 and 4 illustrate an example of hyperspectral image data converted into grayscale and RGB image representation formats for visualization purposes according to one embodiment of the present invention. Although displayed in a limited number of bands for human interpretation, the underlying hyperspectral dataset includes reflectance information across numerous spectral bands. The payload processor is operable to analyze the full spectral dataset to distinguish between terrain materials including rock, sand, sparse vegetation, and/or man-made materials such as asphalt or concrete roadways.

In the environment shown in FIGS. 3 and 4, roadways 302 traversing variable terrain provide linear features and/or intersection nodes suitable for alignment with stored vector map data and/or image-to-image comparison. Hyperspectral analysis enables material-based discrimination of roads from surrounding soil and rock, even where visual contrast is limited. For example, asphalt and compacted road materials exhibit spectral signatures distinguishable from natural environmental surfaces. The payload processor is operable to generate or extract a material layer from the hyperspectral data including road centerlines, road edges, intersections, vegetation, soil, buildings, mountain ridges, physical formations, edges, coastlines, rivers, and/or other distinct variation which are then matched to corresponding features in an onboard vector map. By identifying materials or differences in spectral response rather than solely on visual contrast, the system is operable to improve georectification accuracy in aligning captured imagery to a known coordinate system prior to downlink.

In one embodiment, the payload processor is operable to perform spectral unmixing, band-ratio analysis, supervised and/or unsupervised classification, and/or machine learning-based material identification to generate and/or use a material map from the hyperspectral image data. Using the material map, the payload processor is operable to extract linear and/or geometric features including road centerlines, road edges, intersections, coastlines, rivers, airport runways, rail corridors, parking lot boundaries, and/or other structural features. Edge detection, contour tracing, Hough transforms, and/or graph-based line extraction techniques are operable to be utilized to convert regions into features suitable for comparison with stored vector datasets.

The extracted features are operable to be matched against stored onboard vector maps by comparing geometric features including line segments, node intersections, curvature, and/or spatial relationships. In one embodiment, the payload processor is operable to perform a spatial transformation that aligns the extracted features and corresponding stored vector features to georectify the captured image data to a known coordinate system.

In contrast to conventional ground-based workflows, which often rely primarily on RGB imagery and manual, semi-automated, or fully automated feature identification, the present onboard system leverages hyperspectral material signature differences to improve georectification accuracy. The onboard approach eliminates reliance on post-downlink processing and enables near real-time feature extraction and spatial alignment prior to transmission from the satellite.

### Optical Communication and Reference Data Updates

In one embodiment, the artificial satellite includes an optical transceiver and/or transponder operable to communicate via optical inter-satellite links and/or optical ground stations. The optical communication system enables the reception of reference data at the satellite at data rates substantially higher than traditional radiofrequency uplinks. This capability overcomes bandwidth limitations that previously substantially prevented transmission of reference imagery, reference data, or mapping data to satellites in orbit.

In one embodiment, the system is operable to receive a reference data package concurrently with a tasking instruction. The reference data package includes one or more pre-georectified images, maps, vector maps, AIS data, or reference datasets all with GIS information included and operable to correspond to a target area the artificial satellite is capturing images for. The payload processor is operable to store the reference data in the onboard memory and use it to georectify or position rectify newly captured image data prior to downlink from the satellite to a ground station or at least one other receiver.

### Image-to-Image Matching and Position Rectification

In one embodiment, the payload processor is operable to perform georectification using image data generated by the at least one sensor on the artificial satellite compared against a previously georectified reference image or map stored onboard the artificial satellite. The payload processor is operable to execute image analysis algorithms including edge detection, landmark identification, pattern correlation, and/or feature matching to identify corresponding patterns on a pixel-by-pixel basis between image data generated by at least one sensor on the satellite and the reference image or map. Based on the identified correspondences, the payload processor is operable to compute a spatial transformation that maps and/or adjusts the newly captured image to a known coordinate system. In one embodiment, this process is referred to as position rectification, where the system determines the precise spatial position of the image using at least one available onboard reference data source including reference images, vector maps, AIS data, satellite orbit data, attitude data, velocity data, and/or timing information.

In one embodiment, for example, the reference data is operable to include at least one highly detailed grayscale image depicting coastlines, urban environments, landmarks, roads, rivers, or other high-contrast features. The payload processor is operable to match newly captured hyperspectral or multispectral image data to the grayscale reference image to determine precise spatial alignment.

In one embodiment, the payload processor is operable to perform pan-sharpening using onboard reference data and image-to-image matching techniques. The payload processor is operable to extract spatial detail from the reference data into the image data to generate a pan-sharpened image that preserves spectral characteristics while improving spatial resolution. In one embodiment, the reference image used for pan-sharpening is generated onboard during a same imaging pass. In another embodiment, the reference image is a previously captured and stored image, a pre-georectified reference image received via an optical communication link, or a reference image associated with known spatial coordinates. The resulting pan-sharpened image is further operable to be position rectified or georectified using the same or additional reference data prior to downlink from the artificial satellite.

In one embodiment, the payload processor is operable to perform orthorectification of image data using onboard reference data and/or image-to-image matching techniques. Image data captured by the at least one imaging sensor is operable to include distortions caused by sensor viewing geometry, satellite attitude, orbital motion, terrain, and/or Earth curvature. To correct these distortions, the payload processor is operable to access onboard reference data, including at least one pre-georectified image, vector map, digital elevation model (DEM), and/or terrain model stored in the onboard memory and/or received via optical communication. The payload processor is operable to identify correlating features between the captured image data and the reference data using image-to-image matching methods, including landmark detection, edge matching, contour matching, and/or pattern recognition. Based on the identified features and known imaging geometry of the at least one imaging sensor, the payload processor is operable to compute a geometric transformation that maps pixel locations in the captured image data to their true ground position. The orthorectified image data is thereby transformed into a uniform scale representation operable to be aligned with a known coordinate system and output as an analytics-ready data product prior to transmission from the satellite.

### AIS-Based Geospatial Anchoring

In one embodiment, the artificial satellite is operable to receive and utilize externally generated positional signals/data as supplemental spatial reference information for onboard position rectification or georectification of the image data from the at least one sensor. The externally generated positional signals/data provide known real-world locations associated with identifiable objects within the sensed environment and are particularly useful in regions where fixed terrestrial reference features are sparse or unavailable. An example of a specific region where fixed terrestrial reference features are sparse or unavailable includes large bodies of water, which make AIS data particularly useful as an externally generated positional signal. The payload processor is operable to correlate image data generated by the at least one imaging sensor with the externally generated positional signals to establish one or more spatial anchor points used in determining spatial position information for the image data.

In one embodiment, the artificial satellite includes a radiofrequency receiver operable to receive signals in a very high frequency (VHF) band and configured to receive AIS transmissions broadcast by maritime vessels. The AIS transmissions include vessel identification, position, course, and/or speed data derived from global positioning system (GPS) coordinates transmitted by the vessels. The payload processor is operable to associate vessels detected in image data generated by one or more imaging sensors with corresponding AIS transmissions and is further operable to use the AIS-derived position information as a geospatial anchor for position rectification of the image data.

The payload processor is operable to temporally and/or spatially correlate AIS data with the image data generated by the at least one imaging sensor by associating a time of receipt of an AIS transmission with a time of image capture and identifying a corresponding object within the image data based on expected position, motion, and/or physical characteristics of at least one maritime vessel. The payload processor is further operable to utilize known imaging geometry of the at least one imaging sensor, attitude, and/or position data of the artificial satellite, and the AIS-derived position information to establish at least one spatial anchor point within the image data. The at least one spatial anchor point is then used by the payload processor to determine a spatial transformation that maps pixel locations within the image data to real-world coordinates, thereby performing position rectification/georectification prior to transmission.

In another embodiment, the AIS data is obtained from another satellite or constellation via optical inter-satellite communication, from at least one base station, and/or from an onboard AIS database stored in memory. AIS-based anchoring is particularly useful in open ocean environments where fixed terrestrial landmarks are unavailable. However, AIS data is not required for georectification, and the system is operable to perform position rectification/georectification using alternative methods discussed herein when AIS data is unavailable or unreliable.

In one embodiment, correlation between AIS transmissions/data and vessels detected in image data is performed using a multi-parameter association process operable to be executed by the payload processor. Each AIS transmission/data is operable to include vessel position, timestamp, course, speed, and/or vessel identification data. The payload processor is operable to temporally align the AIS transmissions/data with the image capture time and predicts expected vessel positions within the imaging footprint based on reported speed and heading over the time interval between AIS broadcast and image acquisition. Once AIS data has been temporally aligned with image data and the vessel corresponding to the AIS data has been identified, the image is operable to be georectified based on the position information from the AIS data.

In another embodiment, the payload processor is operable to detect specific candidate vessels within the captured image data using spectral classification, shape detection, wake detection, size estimation, and/or contrast-based object detection methods. Hyperspectral imagery is further operable to identify vessel material composition, including metal hull characteristics, deck materials, paint reflectance properties, and/or other spectral signatures that provide a distinguishable fingerprint for a given vessel.

In one embodiment, when multiple vessels are present in an image and at least one AIS transmission is received, the payload processor is operable to perform a matching process that evaluates spatial proximity, projected motion, vessel size estimates, heading alignment, a distinguishable spectral fingerprint for a specific vessel and/or spectral signatures to associate at least one vessel with the corresponding at least one AIS transmission or AIS record. In one embodiment, a probabilistic matching algorithm or multi-hypothesis tracking method is operable to be utilized to resolve ambiguities when multiple candidate vessel matches exist. In open ocean environments, multiple vessels broadcasting AIS within a single imaging footprint are operable to provide multiple spatial anchor points. Each matched vessel provides a known coordinate that is correlated to a corresponding vessel location in the image. The payload processor is operable to use at least one of these anchor points to compute a spatial transformation for georectification of the entire scene.

In one embodiment, static AIS transmitters including port beacons, lighthouses, offshore platforms, and/or anchored vessels are operable to provide fixed geospatial reference points. Because these transmitters broadcast fixed latitude and longitude coordinates, they are operable to function as precise spatial anchors for georectification in coastal or port environments.

For vessels not broadcasting AIS information, the payload processor is operable to record an observation including time, estimated position, vessel size, wake characteristics, and/or spectral signature. In one embodiment, a database of vessel spectral signatures, radar signatures, visual characteristics, and/or radiofrequency signatures is maintained onboard the artificial satellite and/or at a ground system. Previously correlated observations where AIS was active are operable to associate a spectral fingerprint with a specific vessel identity. Detection of a matching spectral signature when AIS is inactive is operable to identify the vessel and establish chain-of-custody tracking across time. Such detections are operable to be used in maritime domain awareness applications including illegal fishing monitoring, interdiction activities, and/or monitoring of vessels operating without active transponders. Further, if at least one anchor point is captured in an image with one of these vessels not transmitting AIS data with an identified spectral fingerprint the anchor point is operable to be used for verification of location and/or orientation.

AIS data is operable to be further supplemented with additional radiofrequency-derived positional signals including ADS-B transmissions from aircraft, ship-to-shore radar emissions, and/or other RF emitters within the sensed environment. The payload processor is operable to utilize imaging data, RF data, AIS data, and/or additional sensor inputs to improve spatial anchoring accuracy and object identification prior to the transmission of the analytics-ready data product.

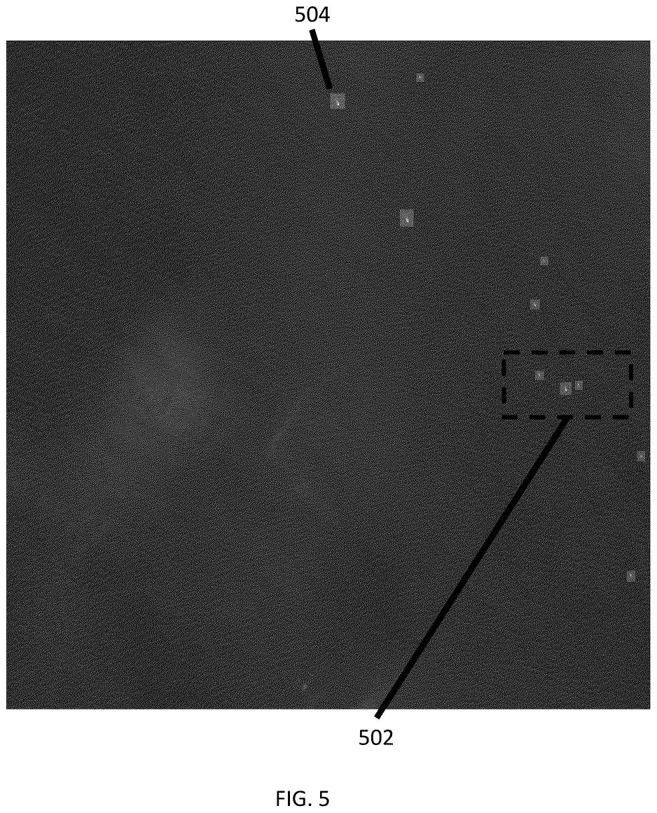

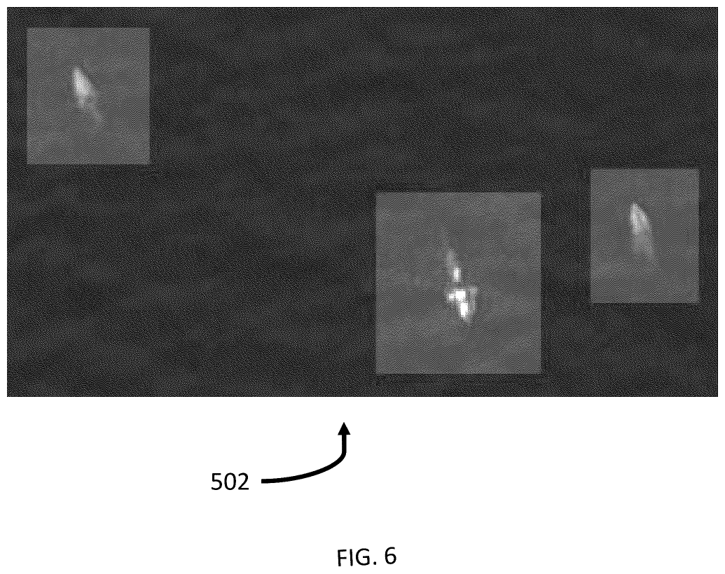

FIGS. 5 and 6 illustrate a maritime scene in which multiple vessels are present within a single imaging footprint and boxed for easy viewer identification according to one embodiment. The displayed RGB image representations are derived from hyperspectral data captured by the artificial satellite. Although the figures are presented in RGB format for visualization, the payload processor is operable to analyze the full hyperspectral signature of each detected vessel.

The payload processor is operable to detect vessels within the scene using contrast detection, shape analysis, wake detection, and/or spectral anomaly identification relative to the surrounding water. Water exhibits a distinct spectral absorption profile, enabling reliable segmentation of ocean surfaces from vessel structures. Each vessel, composed primarily of metal hull materials, painted surfaces, and/or deck equipment, is operable to exhibit a composite spectral signature that functions as a distinguishable fingerprint as previously described. Subtle differences in paint composition, hull coatings, deck materials, and structural configuration produce measurable spectral variations across bands not visible in standard RGB imagery.

A group of three vessels 502 is depicted in FIG. 5 and shown in greater detail in FIG. 6. At least one additional vessel 504 is also depicted in FIG. 5. In one embodiment, AIS data received from the at least one additional vessel 504 is operable to be used as a spatial anchor to geolocate and georectify the entirety of the scene illustrated in FIG. 5, including the group of three vessels 502, even if the group of three vessels 502 is not transmitting AIS data. Further, FIG. 6 illustrates a zoomed-in view of the group of three vessels 502. As previously described, a distinguishable spectral fingerprint associated with each vessel of the group of three vessels 502 is operable to be identified from hyperspectral image data regardless of whether the vessel is transmitting AIS data.

In another embodiment, multiple vessels broadcasting AIS within the imaging footprint are operable to provide multiple geospatial anchor points. The payload processor is operable to associate detected vessels with AIS records using spatial proximity, heading consistency, vessel length, and/or spectral signature comparison. Once two or more vessels are matched to AIS-derived coordinates, the system is operable to compute a spatial transformation that is operable to georectify the maritime scene.

FIG. 6 further illustrates that even visually similar vessels are operable to be distinguished using hyperspectral data. In scenarios where a vessel disables AIS transmission, its spectral signature, vessel dimensions, and/or wake characteristics are operable to be recorded and compared against a database of previously observed vessels whose identities were confirmed when AIS was active. This enables vessel identification and maritime domain awareness, including detection of illicit fishing or other unauthorized activities.

### Multi-Satellite and Orbital Reference Methods

In another embodiment, the artificial satellite is operable to receive/capture positional data derived from at least one other satellite. The system is operable to identify other satellites within the field of view of the imaging sensors and determine their known orbital parameters including position, velocity, and trajectory. The payload processor uses this information, along with relative motion and timing analysis, to infer spatial alignment of the artificial satellite and/or image data. The payload processor is operable to perform multi-image analysis, where multiple images of the same region captured at different times are analyzed to determine relative motion, velocity, and orientation, which are then used to refine georectification accuracy. This is particularly relevant for analytical applications including orbital analysis, satellite tracking, change detection, and/or space situational awareness. The artificial satellite is further operable to obtain spatial information and/or position data from the at least one other satellite via at least one optical receiver.

In one embodiment, orbital data from the artificial satellite and/or from other satellites is operable to be incorporated into position rectification through a geometry-based state determination process. The artificial satellite is operable to maintain knowledge of its own position and velocity using onboard GPS receivers, star trackers, inertial measurement units, and/or orbit propagation models. Precise timekeeping is operable to be maintained using onboard clocks and/or verified via transmission to a ground station or to another satellite.

When imaging another satellite for space domain awareness applications, the payload processor is operable to determine a line-of-sight vector to the imaged object based on pixel location within the image, known sensor field of view, focal length, spacecraft attitude, and/or orientation derived via star field recognition. Background stars within the image are operable to provide a reference frame for refining image orientation information.

Using the known position and velocity of the artificial satellite at the precise time of image capture, the payload processor is operable to combine the line-of-sight information with orbital models to estimate the position of the imaged satellite in space. In one embodiment, catalogs of known space objects, including orbital elements, are operable to be received from publicly available or proprietary sources, stored onboard, and used to correlate observed objects with expected positions. Relative motion analysis, magnitude, apparent size, and/or comparison with predicted trajectories are used to identify known satellites within the field of view.

For observed satellites with unknown or uncertain orbit states, multiple observations collected over time are operable to be processed using orbit determination algorithms. By combining multiple line-of-sight measurements with timing and spacecraft position/orientation information, the payload processor is operable to estimate the position and/or velocity vector of the observed satellite. These determinations are further operable to refine spatial alignment of imagery and support onboard georectification or position rectification processes in space-domain sensing applications.

The incorporation of onboard orbital knowledge, star-field references, timing data, and/or multi-observation analysis enables autonomous spatial determination of objects in orbit without reliance on immediate ground-based processing, thereby extending the onboard analytics-ready data capability of space awareness applications.

### Analytics-Ready Data Product Generation and Differentiation

In one embodiment, the payload processor outputs a fully georectified analytics-ready data product. The analytics-ready data product is operable to include image data embedded with spatial coordinates, metadata describing spatial information, and/or alignment with a geographic coordinate system for use in a GIS. The analytics-ready data product is operable to be transmitted from the satellite to a destination device or node without requiring additional georectification, orthorectification, and/or preprocessing.

This onboard generation of analytics-ready data eliminates traditional ground-based georectification workflows, which often require 30 minutes or more of manual, semi-automated, or fully automated processing. By performing georectification on orbit, the system enables immediate processing of satellite imagery into analytics software, and/or automated decision-making systems.

Unlike prior art systems that rely on ground-based databases, third-party mapping services, and post-downlink processing, the present invention performs georectification using images captured onboard, onboard processing, and onboard reference information. The source of both the captured images and the processing occur in orbit, which represents a fundamental architectural distinction from existing satellite imaging systems and enables low-latency analytics-ready data delivery.

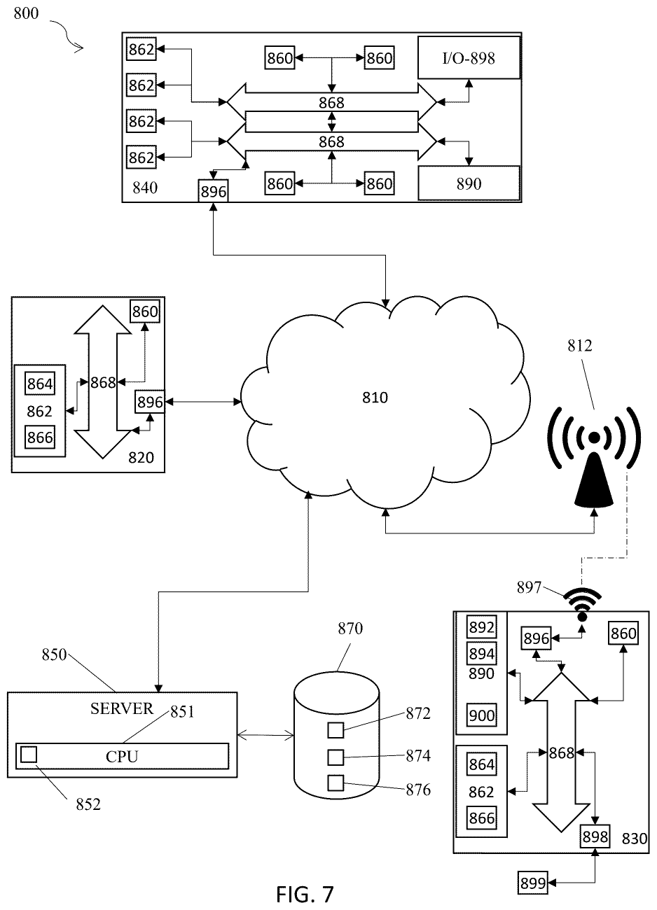

FIG. 7 is a schematic diagram of an embodiment of the invention illustrating a computer system, generally described as 800, having a network 810, a plurality of computing devices 820, 830, 840, a server 850, and a database 870.

The server 850 is constructed, configured, and coupled to enable communication over a network 810 with a plurality of computing devices 820, 830, 840. The server 850 includes a processing unit 851 with an operating system 852. The operating system 852 enables the server 850 to communicate through network 810 with the remote, distributed user devices. Database 870 is operable to house an operating system 872, memory 874, and programs 876.

In one embodiment of the invention, the system 800 includes a network 810 for distributed communication via a wireless communication antenna 812 and processing by at least one mobile communication computing device 830. Alternatively, wireless and wired communication and connectivity between devices and components described herein include wireless network communication such as WI-FI, WORLDWIDE INTEROPERABILITY FOR MICROWAVE ACCESS (WIMAX), Radio Frequency (RF) communication including RF identification (RFID), NEAR FIELD COMMUNICATION (NFC), BLUETOOTH including BLUETOOTH LOW ENERGY (BLE), ZIGBEE, Infrared (IR) communication, cellular communication, satellite communication, Universal Serial Bus (USB), Ethernet communications, communication via fiber-optic cables, coaxial cables, twisted pair cables, and/or any other type of wireless or wired communication. In another embodiment of the invention, the system 800 is a virtualized computing system capable of executing any or all aspects of software and/or application components presented herein on the computing devices 820, 830, 840. In certain aspects, the computer system 800 is operable to be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of electronic devices including at least a processor and a memory, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in the present application.

In one embodiment, the computing device 820 includes components such as a processor 860, a system memory 862 having a random access memory (RAM) 864 and a read-only memory (ROM) 866, and a system bus 868 that couples the memory 862 to the processor 860. In another embodiment, the computing device 830 is operable to additionally include components such as a storage device 890 for storing the operating system 892 and one or more application programs 894, a network interface unit 896, and/or an input/output controller 898. Each of the components is operable to be coupled to each other through at least one bus 868. The input/output controller 898 is operable to receive and process input from, or provide output to, a number of other devices 899, including, but not limited to, alphanumeric input devices, mice, electronic styluses, display units, touch screens, gaming controllers, joy sticks, touch pads, signal generation devices (e.g., speakers), augmented reality/virtual reality (AR/VR) devices (e.g., AR/VR headsets), or printers.

By way of example, and not limitation, the processor 860 is operable to be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown as 840 in FIG. 7, multiple processors 860 and/or multiple buses 868 are operable to be used, as appropriate, along with multiple memories 862 of multiple types (e.g., a combination of a DSP and a microprocessor, a plurality of microprocessors, one or more microprocessors in conjunction with a DSP core).

Also, multiple computing devices are operable to be connected, with each device providing portions of the necessary operations (e.g., a server bank, a group of blade servers, or a multi-processor system). Alternatively, some steps or methods are operable to be performed by circuitry that is specific to a given function.

According to various embodiments, the computer system 800 is operable to operate in a networked environment using logical connections to local and/or remote computing devices 820, 830, 840 through a network 810. A computing device 830 is operable to connect to a network 810 through a network interface unit 896 connected to a bus 868. Computing devices are operable to communicate communication media through wired networks, direct-wired connections or wirelessly, such as acoustic, RF, or infrared, through an antenna 897 in communication with the network antenna 812 and the network interface unit 896, which are operable to include digital signal processing circuitry when necessary. The network interface unit 896 is operable to provide for communications under various modes or protocols.

In one or more exemplary aspects, the instructions are operable to be implemented in hardware, software, firmware, or any combinations thereof. A computer readable medium is operable to provide volatile or non-volatile storage for one or more sets of instructions, such as operating systems, data structures, program modules, applications, or other data embodying any one or more of the methodologies or functions described herein. The computer readable medium is operable to include the memory 862, the processor 860, and/or the storage media 890 and is operable be a single medium or multiple media (e.g., a centralized or distributed computer system) that store the one or more sets of instructions 900. Non-transitory computer readable media includes all computer readable media, with the sole exception being a transitory, propagating signal per se. The instructions 900 are further operable to be transmitted or received over the network 810 via the network interface unit 896 as communication media, which is operable to include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the computer system 800.

In one embodiment, the computer system 800 is within a cloud-based network. In one embodiment, the server 850 is a designated physical server for distributed computing devices 820, 830, and 840. In one embodiment, the server 850 is a cloud-based server platform. In one embodiment, the cloud-based server platform hosts serverless functions for distributed computing devices 820, 830, and 840.

It is also contemplated that the computer system 800 is operable to not include all of the components shown in FIG. 7, is operable to include other components that are not explicitly shown in FIG. 7, or is operable to utilize an architecture completely different than that shown in FIG. 7. The various illustrative logical blocks, modules, elements, circuits, and algorithms described in connection with the embodiments disclosed herein are operable to be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

The invention claimed is:

1. An artificial satellite, comprising:
a satellite body;
an imaging sensor attached to the satellite body, wherein the imaging sensor is operable to generate image data representing a sensed environment;
a memory attached to the satellite body and operable to store reference data having a known position; and
a processor attached to the satellite body and in communication with the imaging sensor and the memory;
wherein the processor is operable to perform position rectification on the image data using the reference data stored in the memory; and
wherein the position rectified image data includes an analytics-ready data product prior to transmission of the position rectified image data from the artificial satellite to a ground station or a second artificial satellite.

2. The artificial satellite of claim 1, wherein the position rectification comprises georectification of the image data into a terrestrial coordinate system for use in a geographic information system (GIS).

3. The artificial satellite of claim 1, wherein the reference data comprises a vector-based map including representations of roads, coastlines, buildings, landmarks, political boundaries, and/or geographic features.

4. The artificial satellite of claim 3, wherein the vector-based map represents at least one predetermined portion of the Earth's surface.

5. The artificial satellite of claim 1, wherein the imaging sensor includes a Red, Green, Blue (RGB) video imaging sensor, a hyperspectral sensor, an ultraviolet instrument, and/or an infrared spectrometer.

6. The artificial satellite of claim 1, wherein the reference data comprises one or more pre-georectified reference images corresponding to a geographic region.

7. The artificial satellite of claim 1, further comprising at least one communication interface, wherein the at least one communication interface comprises an optical communication interface including an optical receiver.

8. The artificial satellite of claim 7, wherein the processor is operable to receive, via the optical receiver, the reference data while the artificial satellite is in orbit.

9. The artificial satellite of claim 1, further comprising an onboard receiver attached to the satellite body operable to receive automatic identification system (AIS) data, wherein the processor is operable to use position data from the AIS data as the reference data.

10. The artificial satellite of claim 9, wherein the AIS data from the onboard receiver is received from a maritime vessel or another satellite and is stored in the memory as the reference data.

11. An artificial satellite, comprising:
a satellite body;
an imaging sensor attached to the satellite body, wherein the imaging sensor is operable to generate image data representing a sensed environment;
a memory attached to the satellite body and operable to store reference data having a known position; and
a processor attached to the satellite body and in communication with the imaging sensor and the memory;
wherein the processor is operable to perform position rectification on the image data using the reference data stored in the memory to associate features within the image data with the reference data; and
wherein the image data includes spatial position information prior to transmission from the artificial satellite to a ground station or a second artificial satellite.

12. The artificial satellite of claim 11, wherein the reference data comprises a vector-based map including representations of roads, coastlines, buildings, landmarks, political boundaries, and/or fixed geographic features.

13. The artificial satellite of claim 11, wherein the imaging sensor includes a Red, Green, Blue (RGB) video imaging sensor, a hyperspectral sensor, a ultraviolet instrument, an infrared spectrometer, and/or a radiofrequency (RF) sensing instrument.

14. The artificial satellite of claim 11, further comprising an onboard radiofrequency (RF) receiver attached to the satellite body operable to receive automatic identification system (AIS) data, wherein the processor is operable to use position data from the AIS data as the reference data.

15. The artificial satellite of claim 11, wherein the reference data comprises one or more pre-georectified reference images corresponding to a geographic region.

16. The artificial satellite of claim 15, wherein the one or more pre-georectified reference images are delivered to the artificial satellite concurrently with at least one imaging instruction.

17. An artificial satellite, comprising:
a satellite body;
an imaging sensor attached to the satellite body, wherein the imaging sensor is operable to generate image data representing a sensed environment;
a memory attached to the satellite body and operable to store reference data having a known position; and
a processor attached to the satellite body and in communication with the imaging sensor and the memory;
wherein the processor is operable to associate features within the image data with the reference data to automatically correct the image data via orthorectification, georectification, and/or pan sharpening to create an analytics-ready data product comprising spatial position information prior to transmission from the artificial satellite to a ground station.

18. The artificial satellite of claim 17, wherein the reference data comprises a vector-based map including representations of roads, coastlines, buildings, landmarks, political boundaries, and/or fixed geographic features.

19. The artificial satellite of claim 17, wherein the orthorectification includes utilizing a digital elevation model.

20. The artificial satellite of claim 17, further comprising an onboard radiofrequency (RF) receiver attached to the satellite body operable to receive automatic identification system (AIS) data, wherein the processor is operable to use position data from the AIS data as the reference data.
